(19) United States
(12) Patent Application Publication
(10) Pub. No.: US 2022/0048817 A1
(43) Pub. Date: Feb. 17, 2022

(54) LOW BUOYANCY CELLULAR CONCRETE

(71) Applicant: Cellular Concrete Solutions LLC, Golden, CO (US)

(72) Inventors: Brian Masloff, Westminster, CO (US); Joseph Feiler, Littleton, CO (US); Milton Gomez, Allentown, PA (US)

(21) Appl. No.: 17/399,945

(22) Filed: Aug. 11, 2021

Related U.S. Application Data
(60) Provisional application No. 63/064,798, filed on Aug. 12, 2020.

(51) Int. Cl. C04B 7/02; B28B 1/50; C04B 7/36

(52) U.S. Cl. CPC C04B 7/02; B28B 1/50; C04B 2235/77; C04B 2235/9607; C04B 7/36

(57) ABSTRACT

Implementations described and claimed herein provide a process for creating a low-buoyancy cellular concrete that may include cement, water, and various surfactants including hydrophilic additives to produce the low-buoyancy cellular concrete. The low-buoyancy cellular concrete wet mix maintains its cellular properties while it is placed and cures. After curing, water may be absorbed into the low buoyancy cellular concrete via a combination of physical and chemical characteristics. An open cell structure of capillaries facilitates wicking action of water into the low buoyancy cellular concrete via capillary channeling (through the cementitious matrix between the micro-bubbles, and in some cases into the micro-bubbles as well). Further, the hydrophilic additive in the foam surfactant facilitates absorption of water into the low buoyancy cellular concrete through diminished surface tension at an interface of the cellular concrete and a body of water and at and between the microbubbles.

### CROSS-REFERENCE TO RELATED APPLICATIONS

The present application claims benefit of priority to U.S. Provisional Patent Application No. 63/064,798, entitled “Low Buoyancy or Non-Buoyant Cellular Concrete” and filed on 12 Aug. 2020, which is specifically incorporated by reference herein for all that it discloses or teaches.

### BACKGROUND

Concrete is used more than any other manmade material on the planet. As of 2005, about six billion cubic meters of concrete are made each year, which equals one cubic meter for every person on earth. Further, more than 55,000 miles of freeways and highways in the U.S.A. alone are made of concrete. The type of structure being built, as well as its method of construction, determines how the concrete is placed and a composition of the wet concrete mix. At least water, fine and/or coarse aggregates, and cement (e.g., Portland cement) are combined to form the wet concrete mix. A water to cement ratio (e.g., mass ratio of water to cement) of the wet mix is a primary factor in defining strength of the resulting cured concrete. In addition, chemical admixtures (e.g., powders or fluids) are added to the concrete wet mix to give it characteristics beyond that of plain wet mixes. Example admixtures include accelerators, retarders, air-entrainers that add and distribute tiny air bubbles in the concrete, high-range water reducers that increase capillary absorption, pigments, corrosion inhibitors, bonding agents, pumping aids, and so on.

Cellular concrete utilizes micro-bubbles, which are formed via agitation with a foaming agent admixture acting to form and maintain the micro-bubbles within a wet mix as it cures. The micro-bubbles may trap sufficient air within the cellular concrete that it is buoyant in wet conditions (e.g., in placements at or below a water table underground or various underwater placements). As an example, a roadway built out of cellular concrete that is lighter than water (i.e., buoyant in the presence of water) may be damaged by uplift of the cellular concrete floated by the water. In some circumstances, a surcharge of heavier overburden material may be used to compensate for the buoyancy of cellular concrete material. However, if the cellular concrete is intended to be a top layer, a surcharge of heavier overburden material is not an available option.

### SUMMARY

Implementations described and claimed herein address the foregoing problems by providing a cured low buoyancy cellular concrete comprising cement distributed throughout the cellular concrete, aggregate distributed throughout the cellular concrete, and a foaming agent residue that defines a distributed array of micro-bubbles within the low buoyancy cellular concrete. A density of the low buoyancy cellular concrete is greater than 930 kg/m³ when water is allowed to absorb into the low buoyancy cellular concrete and less than 930 kg/m³ when water is allowed to exude from the low buoyancy cellular concrete.

Implementations described and claimed herein further address the foregoing problems by further providing a wet low buoyancy cellular concrete comprising water distributed throughout the cellular concrete, cement distributed throughout the cellular concrete, aggregate distributed throughout the cellular concrete, and a foaming agent distributed throughout the cellular concrete. The cellular concrete product contains a distributed array of micro-bubbles that substantially maintain their presence in the cellular concrete product as it cures. The foaming agent includes a hydrophilic additive.

Implementations described and claimed herein still further address the foregoing problems by still further providing a method of manufacturing a low buoyancy cellular concrete product comprising combining water, a foaming agent including a hydrophilic additive, cement, and aggregate to create a wet cellular concrete that contains a distributed array of micro-bubbles that substantially maintain their presence in the wet cellular concrete product as it cures; and curing the wet cellular concrete to create the low buoyancy cellular concrete product. A density of the low buoyancy cellular concrete is greater than 930 kg/m³ when water is allowed to absorb into the low buoyancy cellular concrete and less than 930 kg/m³ when water is allowed to exude from the low buoyancy cellular concrete.

This Summary is provided to introduce a selection of concepts in a simplified form that are further described below in the Detailed Description. This Summary is not intended to identify key or essential features of the claimed subject matter, nor is it intended to be used to limit the scope of the claimed subject matter. Other features, details, utilities, and advantages of the claimed subject matter will be apparent from the following written Detailed Description and as illustrated in the accompanying drawings.

Other implementations are also described and recited herein.

### BRIEF DESCRIPTIONS OF THE DRAWINGS

FIG. 1 illustrates an example partial cross-sectional diagram of a low buoyancy cellular concrete product in a wet state.

FIG. 2 illustrates an example partial cross-sectional diagram of a low buoyancy cellular concrete product in a cured state.

FIG. 3 illustrates an example partial cross-sectional diagram of a low buoyancy cellular concrete product absorbing water through capillary action.

FIG. 4 illustrates a series of example cellular concrete placements, each with varying levels of buoyancy.

FIG. 5 illustrates further example low buoyancy cellular concrete placements.

FIG. 6 illustrates example operations for preparing and using low buoyancy cellular concrete.

### DETAILED DESCRIPTION

Implementations described and claimed herein provide a cellular concrete product that obtains a low buoyancy defining characteristic in the presence of water. The low buoyancy cellular concrete maintains a relatively low weight per unit volume when saturated at less than 50%. Further, the low buoyancy cellular concrete may readily permit water to pass through it (readily pervious) or prevent water from passing through it (readily impervious), independent of absorption of water via the capillary action described in further detail below, depending on intended design constraints.

Various formulations for a low-buoyant to non-buoyant cellular concrete (collectively referred to herein as “low buoyancy cellular concrete” or “LBCC”) and methods for making the low buoyancy cellular concrete are provided below. The low buoyancy cellular concrete may have an internal structure comprising an array of microbubbles surrounded by a cementitious matrix that allows the low buoyancy cellular concrete to have a relatively low unsaturated weight per unit volume, but still achieve a low-buoyant to non-buoyant characteristic when saturated. In various implementations, the disclosed low buoyancy cellular concrete has a hydraulic conductivity (K) value of about 1 to about 1×10⁻⁸ cm/sec, a cast density range of between about 10 to about 58 pounds per cubic foot (pcf), a saturated density of about 40 to about 120 pcf, with a compressive strength of between about 10 to about 1200 psi and absorption into the material of about 10 to about 90 percent of the mass of the low buoyancy cellular concrete, and a slump value of about 2 to about 11.5 inches.

In various implementations, the low buoyancy cellular concrete is formed from a base wet mix and a foam where the foam includes a hydrophilic additive that encourages absorption of water via capillary action through the cementitious matrix existing between the array of microbubbles. The foam may be pre-generated (generated and then added to the base mix slurry) or added to the base mix slurry without being pre-generated. The pre-generated foam may comprise from about 30% to about 95% of the base composite volume of the low buoyancy cellular concrete with the base mix slurry comprising the remainder of the low buoyancy cellular concrete. Also, the base mix slurry may comprise about 2% to about 60% water, about 5% to about 80% cement, about 5% to about 95% of a pozzolan, about 5% to about 80% aggregate (e.g., sand), by weight. In various implementations, the low buoyancy cellular concrete may be pumpable or non-pumpable.

Other implementations provide a method for forming a low buoyancy cellular concrete comprising a base mix slurry in a vessel, preparing a foam, injecting the foam into the base mix slurry in the vessel to form a foam mix, mixing the foam mix to form a wet mix, pumping the wet mix, and allowing the wet mix to dry and harden (collectively, cure) to form low buoyancy cellular concrete.

The foam composition is specifically designed to facilitate absorption of water into the low buoyancy cellular concrete via a combination of physical and chemical characteristics. A cell structure of capillaries is formed within the low buoyancy cellular concrete. This cell structure facilitates wicking action of water into the low buoyancy cellular concrete via capillary channeling (through the cementitious matrix between the micro-bubbles, and in some cases into the micro-bubbles as well). A hydrophilic additive in the foam surfactant facilitates absorption of water into the low buoyancy cellular concrete through diminished surface tension at an interface of the cellular concrete and a body of water and at and between the microbubbles, depending on the composition of the surfactants used in the foam agent.

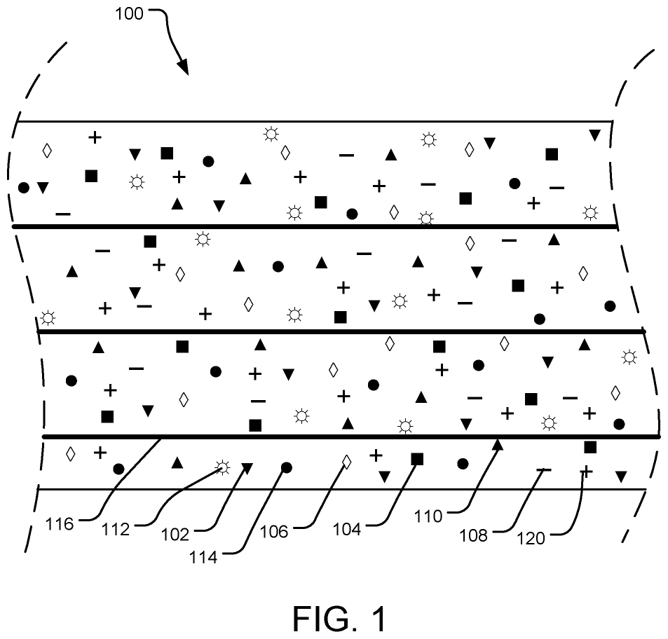

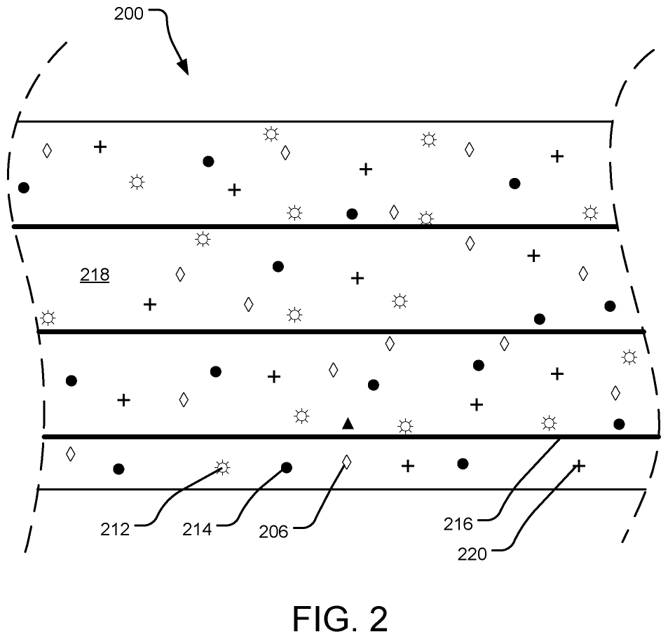

FIG. 1 illustrates an example partial cross-sectional diagram of a low buoyancy cellular concrete product 100 in a wet state. The cellular concrete product 100 is a material that is composed of a variety of constituent components, some of which are illustrated by symbols in FIG. 1, as described in detail below. When the constituent components are mixed, they form a fluid mass that may be molded into a desired shape. Over time, some of the constituent components form a hard matrix which binds the rest of the constituent components together into a durable stone-like material with many uses (see e.g., cellular concrete product 200 of FIG. 2 in a cured state).

While the cellular concrete product 100 is shown in a partial slab form in FIG. 1, in other implementations, it may take any desired overall shape. Further, while the constituent components of the cellular concrete product 100 are depicted in relative equal proportion in FIG. 1, in various implementations the proportions of each constituent component may vary widely, and in some cases constituent components may be omitted entirely.

The cellular concrete product 100 includes cement (e.g., “Portland cement”) particles (e.g., particle 102, illustrated by “▾” symbols in FIG. 1). The cement is a binder (a substance that sets and hardens and can bind other constituent materials together). Belite (2CaO.SiO₂), Alite (3CaO.SiO₂), Celite (3CaO.Al₂O₃), Brownmillerite (4CaO.Al₂O₃.Fe₂O₃) are the main chemical components present in cement. In various implementations, the cellular concrete product 100 may contain 2% to 98% by weight of cement. The cellular concrete product 100 also includes fly ash particles (e.g., fly ash particle 104, illustrated by “▪” symbols in FIG. 1). The fly ash particles include one or both of fly ash and flue ash, for example.

The cellular concrete product 100 also includes aggregate particles (e.g., aggregate particle 106, illustrated by “⋄” symbols in FIG. 1). The aggregate particles may include fine and/or coarse aggregates including, but not limited to sand, gravel, clay, soil, and crushed stone. Further, the aggregate may also include recycled material (e.g., waste material from construction, demolition, and/or excavation activities). Still further, the aggregate may include manufacturing by-products (e.g., blast furnace slag and bottom ash). In various implementations, the cellular concrete product 100 may contain 2% to 98% by weight of aggregate.

The cellular concrete product 100 also includes mineral admixture particles (e.g., mineral admixture particle 108, illustrated by “−” symbols in FIG. 1). The mineral admixture(s) have pozzolanic or latent hydraulic properties and are added to the cellular concrete product 100 to improve performance characteristics of the cellular concrete product 100 and/or as a partial or full replacement for the cement (e.g., forming a blended cement). Fly ash is an example mineral admixture. Other potential mineral admixture(s) include limestone, blast furnace slag, zeolite, vermiculite, pumice, and other materials with pozzolanic or latent hydraulic properties. In various implementations, the cellular concrete product 100 may contain 2% to 98% by weight of mineral admixtures.

The cellular concrete product 100 also includes water molecules (e.g., water molecule 110, illustrated by “▴” symbols in FIG. 1). Combining the water with the cement, fly ash, or other mineral admixture constituent materials forms a cement paste by the process of hydration. The cement paste glues the aggregate together, fills voids within the cellular concrete product 100, and makes the cellular concrete product 100 flow in a fluidic manner. In various implementations, the cellular concrete product 100 may contain 5% to 80% by weight of water.

The cellular concrete product 100 also includes chemical admixture molecules (e.g., chemical admixture molecule 112, illustrated by “ [symbol] ” symbols in FIG. 1). The chemical admixtures are materials (typically in the form of powder or fluid) that are added to the cellular concrete product 100 to apply or enhance desired characteristics (e.g., accelerators, retarders, high-range water reducers, pigments, corrosion inhibitors, bonding agents, and pumping aids) of the cellular concrete product 100.

The cellular concrete product 100 also includes foaming agent molecules (e.g., foaming agent molecule 120, illustrated by “+” symbols in FIG. 1). The foaming agent is added to the cellular concrete product 100 to form a cellular matrix of micro-bubbles (see below) in the cellular concrete product 100. The foaming agent includes one or more hydrophilic additives to promote absorption of water into a resulting cured cellular concrete product (see e.g., cellular concrete product 200 of FIG. 2). In various implementations, the foaming agent includes one or more of: hexylene glycol, sodium chloride, glycerin, ferrous sulfate, cocamidroporpyl betaine, dipropylene glycol monomethyl, zinc chloride, sodium alkyl ether sulfate, triethanol, sodium citrate, C14-C16-alkane hydroxy, Sodium laureth sulfate, tetrasodium pyrophosphate, Dipropylene glycol methyl ether, Alpha olefin sulphonate, and Ethylene Glycol Monobutyl Ether, and various mid to high range water reducers (e.g., polycarboxilates).

Further, a cellulose ether (e.g., “hydroxypropyl methylcellulose”) may be added to the cellular concrete product 100 as a thickening agent and/or a surfactant that coats the micro-bubbles, preventing or reducing collapse of the micro-bubbles. In various implementations, the cellular concrete product 100 may contain 0.001% to 5% by volume of foaming agent(s). In various implementations, the cellular concrete product 100 may also contain 0.001% to 5% by volume of cellulose ether(s). In various implementations, the cellular concrete product 100 may further contain 0.01% to 30% by weight or 0.001% to 5% by volume of other chemical admixture(s).

The cellular concrete product 100 also includes micro-bubbles (e.g., micro-bubble 114, illustrated by “•” symbols in FIG. 1), which are formed via agitation with the foaming agent acting to help form and substantially maintain the micro-bubbles in the cellular concrete product 100 as it cures (e.g., measured by maintaining greater than 75% or greater than 95% cellular concrete product 100 volume as it cures). More specifically, the micro-bubbles within the cellular concrete product 100 resist dissipation such that the cellular concrete product 100 has less than 25% loss of volume as it cures. In various implementations, the cellular concrete product 100 may contain micro-bubbles that range from 500 to 1100 microns in diameter and 10% to 98% by volume of micro-bubbles. The proportions of the constituent materials in the cellular concrete product 100 permit the cellular concrete product 100 to have a gelling characteristic, with a viscosity significantly greater than conventional cellular concrete products (i.e., 500-90,000 cP), which allows the cellular concrete product 100 to be workable, while retaining its cellular matrix of micro-bubbles.

In various implementations, the wet cellular concrete product 100 has a density ranging between 160 to 1600 kilograms per cubic meter and a slump value ranging between 2 to 11.5 (or 3 to 8). The cellular concrete product 100 also includes structural reinforcement (e.g., reinforcing steel rod 116). The cellular concrete product 100 is naturally strong in compression when cured, as the aggregate efficiently carries a compression load on the cellular concrete product 100. However, the cellular concrete product 100 is weak in tension as the cementitious constituent materials holding the aggregate in place can crack, allowing the cellular concrete product 100 to fail. The structural reinforcement adds one or more of steel reinforcing bars, steel fibers, glass fibers, or plastic fibers to carry tensile loads applied to the cellular concrete product 100.

FIG. 2 illustrates an example partial cross-sectional diagram of a low buoyancy cellular concrete product 200 in a cured state. The cellular concrete product 200 is a material that is composed of a variety of constituent components, some of which are illustrated by symbols in FIG. 2, as described in detail below. When the constituent components are mixed, they form a fluid mass that may be molded into a desired shape (see e.g., cellular concrete product 100 of FIG. 1 in a wet state). Over time, some of the constituent components form a hard binder 218 which binds the rest of the constituent components together into a durable stone-like material with many uses.

While the cellular concrete product 200 is shown in a partial slab form in FIG. 2, in other implementations, the cellular concrete product 200 may take any desired overall shape. Further, while the constituent components of the cellular concrete product 200 are depicted in relative equal proportion in FIG. 2, in various implementations the proportions of each constituent component may vary widely, and in some cases constituent components may be omitted entirely. Still further, the hard binder 218 is illustrated as the space surrounding the other depicted constituent components, but the proportion of the hard binder 218 with reference to the other depicted constituent components may vary widely from that shown in FIG. 2.

The cellular concrete product 200 includes aggregate particles (e.g., aggregate particle 206, illustrated by “⋄” symbols in FIG. 2). The aggregate particles may include fine and/or coarse aggregates including, but not limited to sand, gravel, clay, soil, and crushed stone. Further, the aggregate may also include recycled material (e.g., waste material from construction, demolition, and/or excavation activities). Still further, the aggregate may include manufacturing by-products (e.g., blast furnace slag and bottom ash).

The cellular concrete product 200 also includes chemical admixture residue (e.g., chemical admixture molecule 212, illustrated by “ [symbol] ” symbols in FIG. 2). The chemical admixture residue is what remains of a chemical admixture previously added to the cellular concrete product in a wet state (see e.g., cellular concrete product 100 of FIG. 1) to obtain or enhance desired characteristics of the cellular concrete product 200.

The cellular concrete product 200 also includes a foaming agent residue (e.g., foaming agent residue molecule 220, illustrated by “+” symbols in FIG. 2). The foaming agent residue may remain within the cellular concrete product 200 after it cures, primarily surrounding the cellular matrix of micro-bubbles (see below) in the cellular concrete product 200. The foaming agent residue may include a hydrophilic additive to promote absorption of water into the cellular concrete product 200. Further, a cellulose ether residue may also remain within the cellular concrete product 200 after it cures. In various implementations, some or all of the chemical admixture(s) and/or foaming agent(s) chemically combine with other constituent materials to form the binder material 218.

The cellular concrete product 200 also includes the micro-bubbles (e.g., micro-bubble 214, illustrated by “•” symbols in FIG. 2), which are formed via agitation with the foaming agent acting to help form and maintain the micro-bubbles in the cellular concrete product 200 as it cures. The micro-bubbles resist dissipation such that the cellular concrete product 200 has less than 25% loss of volume as it cures.

The hard binder material 218 holds the other constituent materials together in a cured state and is formed from chemical reactions between a combination of the cement, fly ash, other mineral admixtures, and/or water, as discussed above with reference to the cellular concrete product 100 in a wet state, as shown in FIG. 1. In some implementations, the cellular matrix of micro-bubbles may link together during a curing process to form a number of connected pathways (not pictured) in the cellular concrete product 200. The connected pathways may allow the cellular concrete product 200 to be pervious or semi-pervious. In other implementations, the micro-bubbles remain substantially separate and distinct, making the cellular concrete product 200 substantially impervious. In various implementations, the cellular concrete product 200 has a high hydraulic conductivity (K) value, between 1 and 1×10⁻³ cm/s. In other implementations, the cellular concrete product 200 can be highly absorptive but less hydraulically conductive having a K value between 1×10⁻³ and 1×10⁻⁸ cm/s.

The cellular concrete product 200 also includes structural reinforcement (e.g., reinforcing steel rod 216). The cellular concrete product 200 is naturally strong in compression, as the aggregate efficiently carries a compression load on the cellular concrete product 200. However, the cellular concrete product 200 is weak in tension as the cementitious constituent materials holding the aggregate in place can crack, allowing the cellular concrete product 200 to fail. The structural reinforcement adds one or more of steel reinforcing bars, steel fibers, glass fibers, or plastic fibers to carry tensile loads applied to the cellular concrete product 200.

Because of the matrix of micro-bubbles within the cellular concrete product 200, the cellular concrete product 200 may be more resistant to fire and may provide better thermal insulation than conventional concrete. In various implementations, the cured cellular concrete product 200 has a density ranging between 160 to 1600 kilograms per cubic meter, with a compressive strength ranging between 70 to 7000 kPa (or 70 to 3500 kPa).

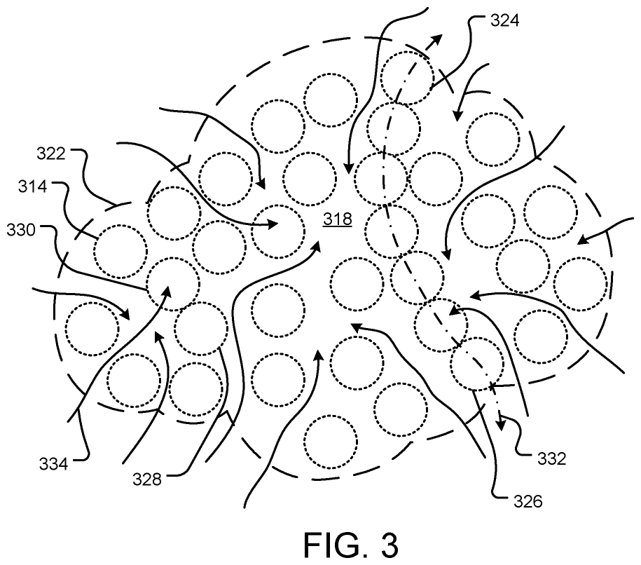

FIG. 3 illustrates an example partial cross-sectional diagram of a low buoyancy cellular concrete product 300 absorbing water through capillary action. The cellular concrete product 300 is a material that is composed of a variety of constituent components, as described in detail above. When the constituent components are mixed, they form a fluid mass that may be molded into a desired shape (see e.g., cellular concrete product 100 of FIG. 1 in a wet state). Over time, some of the constituent components form a hard binder 318 (also referred to as a cementitious matrix), which binds the rest of the constituent components together into a durable stone-like material with many uses.

The cellular concrete product 300 may take any desired overall shape, though only an interior portion of the cellular concrete product 300 inside dashed cloud 322 is shown. The hard binder 318 is illustrated as the space surrounding a matrix of micro-bubbles illustrated in dotted lines (e.g., micro-bubble 314), which suspends the micro-bubbles in place. The hard binder 318 includes various constituent components of the cellular concrete product 300 (e.g., one or more of cement, aggregate, mineral admixtures, chemical admixture residues, and foaming agent residues).

In some implementations, the cellular concrete product 300 is relatively pervious (such as having a hydraulic conductivity (K) value greater than 1×10⁻³ cm/s). This is accomplished by arranging a significant quantity of the micro-bubbles in a connected fashion through the cellular concrete product 300. For example, micro-bubbles 324, 326 are illustrated as endpoints in a chain of micro-bubbles in FIG. 3. As a result, water may pass through the chain of micro-bubbles and thus through the depicted portion of the cellular concrete product 300, as illustrated by dot-dash arrow 332. Should numerous similar chains of micro-bubbles extend through the entire cellular concrete product 300, the cellular concrete product 300 is rendered pervious to water passing through it via the chains of connected micro-bubbles. The chains of connected micro-bubbles may also be referred to herein as an open-pore structure of the cellular concrete product 300.

In other implementations, the cellular concrete product 300 is relatively impervious (such as having a hydraulic conductivity (K) value less than 1×10⁻³ cm/s). Most or all of the micro-bubbles are disconnected from one another, or at least they do not connect continuously through the entire cellular concrete product 300. For example, while micro-bubbles 328, 330 are illustrated as connected, they are disconnected from the micro-bubble 314. The hard binder 318 lies between the micro-bubble 330 and the micro-bubble 314. As a result, water may not pass through chains of micro-bubbles and thus is blocked from passing through the depicted portion of the cellular concrete product 300. The disconnected micro-bubbles may also be referred to herein as a closed-pore structure of the cellular concrete product 300.

Either of pervious or non-pervious cellular concrete may be capable of absorbing water through capillary action. As used herein, capillary action refers to the capability of the cellular concrete product 300 to readily absorb water into and through the hard binder 318, as illustrated by numerous solid arrows in FIG. 3. The water drawn into the cellular concrete product 300 through capillary action passes through the hard binder 318 between the microbubbles, and in some instances, fills some or a majority of the microbubbles, thereby displacing air within the microbubbles (e.g., as illustrated by solid arrow 334). In this manner, the water absorbs into the cellular concrete product 300.

In various implementations, the micro-bubbles were previously formed using a foaming agent including a hydrophilic additive that promotes the capillary absorption of water into the cellular concrete product 300. After the cellular concrete product 300 is cured, a residue of the foaming agent, including the hydrophilic additive, may be found and concentrated around the micro-bubbles. Reduced surface tension at an interface between a water-saturated area adjacent the cellular concrete product 300, and/or within the hard binder 318 of the cellular concrete product 300 promotes the capillary action.

The absorption of water through capillary action may occur when the cellular concrete product 300 is placed in an area at least partially saturated with water (e.g., undergrade at or below a water table or partially or fully submerged in water). Conversely, if the cellular concrete product 300 is placed in an area that is dry (or at least not saturated with water), the water is drawn out of the cellular concrete product 300 by exuding from the cellular concrete product 300 into the surrounding unsaturated (or less saturated) area. This may be conceptualized in FIG. 3 by reversing the directionality of the solid arrows in FIG. 3 for an exuding condition of the cellular concrete product 300.

Further, the absorbing or exuding capillary action, depending on the water saturation of the area surrounding the cellular concrete product 300, is time dependent. Over time, water absorption into the cellular concrete product 300 or water exuding from the cellular concrete product 300 will reach a steady state condition depending on the saturation level of the area around the cellular concrete product 300. Though, when placed in an area saturated with water, the density of the low buoyancy cellular concrete may equal or become greater than 930 kg/m³ over time. This reduces a tendency to float or prevents the cellular concrete product 300 from floating altogether within a water saturated environment.

In various implementations, the cellular concrete product 300 may be lightweight in that it may be substantially lighter than water (less than 930 kg/m³) when not saturated, and low buoyancy in that it is equal to or heavier than water greater than 930 kg/m³) when fully saturated. Being lightweight when not saturated and low buoyancy when fully saturated are both useful characteristics in a variety of cellular concrete placements.

The cellular concrete product 300 is generally a lightweight pumpable low-buoyant or non-buoyant cellular concrete (LBCC). The LBCC may have an internal structure of capillaries, resulting in a hydraulic conductivity (K) value of about 1 to about 1×10⁻⁸ cm/sec, a unit density range of between about 10 and about 58 pounds per cubic foot, with a compressive strength of between about 10 and 1200 psi.

Example hydraulic conductivity values, expressed as a K value in cm/sec, follow for various types of subgrade soil materials. Coarse gravel and/or rock has a K value of about 1 cm/sec. Sand and/or fine sand has a K value of about 1×10⁻³ cm/sec. Silty sand and/or dirty sand has a K value of about 1×10⁻³ to 1×10⁻⁵ cm/sec. Silt and/or fine sandstone has a K value of about 1×10⁻⁵ to 1×10⁻⁷ cm/sec. Clay and/or mudstone has a K value equal to or greater than about 1×10⁻⁷ cm/sec.

The K values range from about 1 cm/sec, which represents a formation of very high hydraulic conductivity, such as loose gravel, to a K value of less than 1×10⁻⁷ cm/sec, which represents a formation of very low hydraulic conductivity, such as clay. The broad hydraulic conductivity range of the presently disclosed technology may be dependent on the specific LBCC formulation and how the LBCC is mixed, pumped, and used.

There are a multitude of applications where LBCC is suitable, useful, and/or desired, such as in road construction, landscaping, and/or replacement of poor soils. In general, soils such as sands, silty sands, gravel, sand blends, and/or concrete composites including rock or gravel aggregates may be used as backfilling materials. The handling and placement costs of weighty materials, blends, and composites is increasingly expensive due to rising costs of fuel and labor. When these materials are used as backfill, compaction of the underlying soil is often achieved to a density range of 85-130 pounds per cubic foot, for consolidation and to prevent future settlement. However, the underlying subgrade soils may not be capable of supporting such heavy composite formulations. A lighter weight, low to non-buoyant material such as LBCC, may be useful in these scenarios.

Further, LBCC may be used as a geotechnical fill (e.g., as a replacement for unstable soil to reduce subsidence of roadways, bridges, and other structures); backfill and annular space grouting; for providing shock absorption in earthquake zones; for reducing loads in underground structures; for filling voids within silos, abandoned mines, underground tanks and pipelines; and for reducing hydrostatic pressure on retaining walls. In locations with high water tables, LBCC is a useful placement as a non-buoyant subgrade layer beneath roads, sidewalks, parking lots and other structures. In some implementations, the LBCC is generated by injecting a pre-generated foam into a base mix slurry including sand, fly ash, bottom ash, and/or other pozzolan, for example. The resulting wet LBCC is inert, virtually self-leveling (has a high slump value), insulating, may be made in a broad range of densities and compressive strengths once cured, and has no flash point.

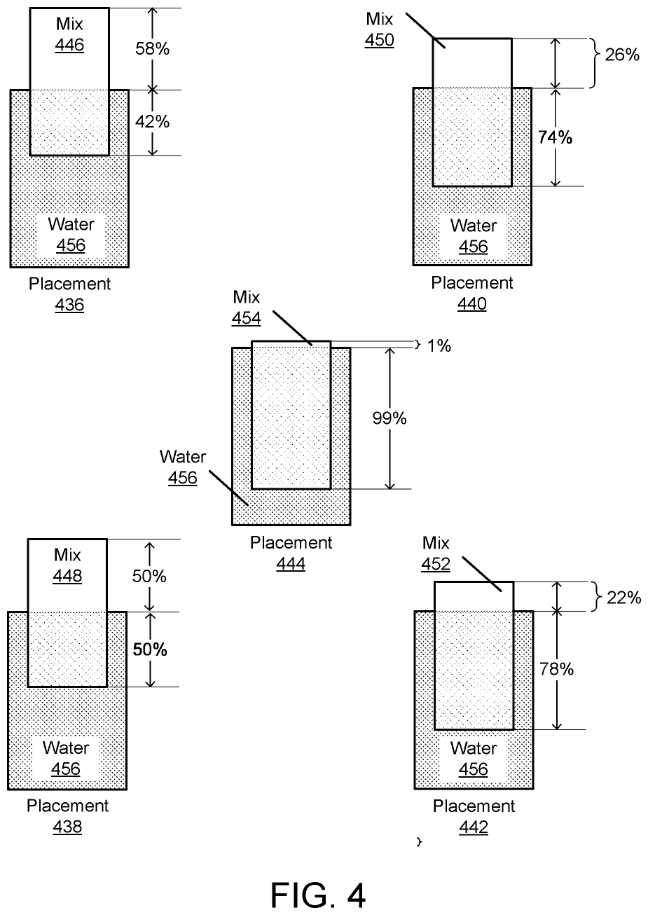

FIG. 4 illustrates a series of example cellular concrete placements 436, 438, 440, 442, 444 each with varying levels of buoyancy. The placements 436, 438, 440, 442, 444 utilize cellular concrete mixes 446, 448, 450, 452, 454 respectively. Each of the placements 436, 438, 440, 442, 444 are of the same relative shape and size and each of the cellular concrete mixes 446, 448, 450, 452 are batched for approximately 30 pounds per cubic foot wet cast density, with identical wet mix ingredients with the exception being that the cellular concrete mixes 446, 448, 450, 452 utilize different foaming agent chemical formulations (e.g., LBCC foam, protein foam, synthetic foam, and protein-synthetic hybrid foam) and/or relative quantities. Table 1 below provides additional detail regarding each of the cellular concrete mixes 446, 448, 450, 452.

TABLE 1

| | | Wet Cast | Oven Dry | Buoyant | Saturated |
|---|---|---|---|---|---|
| Mix | Foaming | Density | Density | Height | Height |
| Number | Agent | (pcf) | (pcf) | (% of total) | (% of total) |
| 446 | A | 30.7 | 23.1 | 58 | 42 |
| 448 | B | 30.6 | 22.3 | 50 | 50 |
| 450 | C | 30.7 | 21.9 | 26 | 74 |
| 452 | D | 30.7 | 22.7 | 22 | 78 |
| 454 | E | 30.8 | 21.1 | 1 | 99 |

After being cured, each of the samples are placed within a container of water 456 and allowed to come to a steady-state buoyant condition within the water 456. Wet Cast Density is the density when the sample is cast in pounds per cubic foot. Oven Dry Density is the density of the sample when fully cured and dried in an oven (representing nearly 0% moisture content). Buoyant Height is the height of the sample that remains out of the water as a percentage of the total height of the sample. Saturated Height is the height of the sample that is submerged in water as a percentage of the total height of the sample. A broad range of cellular concrete buoyancy levels are illustrated, from high-buoyancy cellular concrete (Mix 446) to LBCC (Mixes 450, 452, 454). FIG. 4 and Table 1 illustrate the different levels of buoyancy that can occur in samples of hardened mixtures of cellular concrete, made with different foaming agents and concentrations, but all at the same wet-cast density. Mix No. 446, which is made with a protein-based foam, is representative of a formulation that is highly buoyant, whereas Mix No. 454, which is made with an LBCC-specific foam, renders the resulting sample nearly non-buoyant.

Table 2 below illustrates additional cellular concrete mixes 458, 460, 462, 464, 466, 468, 470 that utilize different foaming agent chemical formulations (e.g., LBCC Foam, protein-synthetic hybrid foam, synthetic non-pervious foam, synthetic pervious foam, and protein-based foam) and foam concentrate/water mixing proportions.

TABLE 2

| Mix Number | Unsaturated | Natural Saturation |
|---|---|---|
| (concentration) | Density (pcf) | Density (pcf) |
| 458 (1:55) | 29.5 | 54.9 |
| 458 (1:40) | 29.1 | 62.1 |
| 460 (1:60) | 29.6 | 53.8 |
| 462 (1:55) | 29.2 | 55.2 |
| 464 (1:60) | 29.3 | 57.7 |
| 464 (1:40) | 30.5 | 60.3 |
| 466 (1:40) | 40.1 | Non-permeable |
| 468 (1:40) | 40.8 | 64.7 |
| 470 (1:40) | 30.7 | Non-permeable |

When generating foam, the foam concentrate is often blended with water prior to mixing with a wet concrete mix. The concentrations above reference a proportion of foam concentrate with reference to water when generating the foam. The mix numbers 458, 460, 462, 464, 466, 468, 470 reference different foaming agent chemical formulations (e.g., LBCC Foam, protein-synthetic hybrid foam, synthetic non-pervious foam, synthetic pervious foam, and protein-based foam).

Unsaturated density references density of a cured sample of the mix with approximately 0% (or less than 8%) water saturation. Natural saturation density references density of a cured sample of the mix when submerged in water and allowed to approach a steady-state density (e.g., achieve 92%+ of steady-state saturation) over a reasonable period of time (e.g., 30 minutes). As water is generally understood to be 62.4 pounds for cubic foot, mix 468 (1:40) is non-buoyant. Further, as mixes 458 (1:40), 464 (1:40) are greater than 58 pounds for cubic foot, at least mixes 458 (1:40), 464 (1:40) are LBCC as understood herein. Mixes 468 (1:40), 458 (1:40), and 464 (1:40) are made using a synthetic surfactant in the foam concentrate. Natural protein-based surfactants may also be used but may not yield a sufficiently low-buoyancy cured cellular concrete placement.

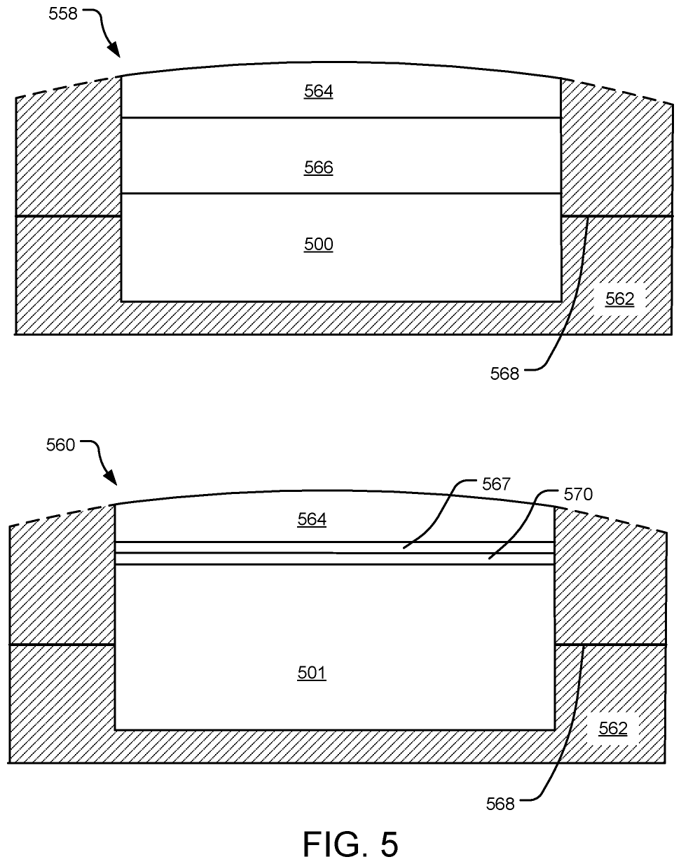

FIG. 5 illustrates further example cellular concrete placements 558, 560. Placement 558 illustrates a swampy or loamy soil 562 with poor load-bearing characteristics and a relatively high water table 568. The soil 562 has been excavated below the water table 568 and filled with high-buoyancy cellular concrete (HBCC) 500 (e.g., placement 436 of FIG. 4). The HBCC 500 reduces soil loading by being lightweight, while providing a stable subbase structure which may support a paved roadway 564. To mitigate the buoyancy of the HBCC 500, a layer of mechanically compacted soil material 566 is placed over the HBCC 500 to counteract the buoyant force of the water acting on and uplifting the HBCC 500. However, placement and compaction of the compacted soil material 566 is costly and time consuming.

Placement 560 illustrates the same paved roadway 564 constructed over the same poor soil 562 and the same high groundwater level (water table 568) as placement 558. However, in placement 560, the excavation is filled with low-buoyancy cellular concrete (LBCC) 501 (e.g., placement 444 of FIG. 4). Placement 560 shows an optional layer of filter fabric 570, which provides a barrier to prevent larger solids from passing into the LBCC 501. As illustrated, the HBCC 500 material of placement 558 and the LBCC 501 material of placement 560 have been dispensed at the same density, which is lower than, and/or about half that of water. As compared to the HBCC 500, LBCC 501 has very little inherent buoyancy since the cell structure within the material permits absorption of more water and a higher field saturation level than other cellular concrete formulations. Further, the LBCC 501 allows more of the excavation to be filled with LBCC, further reducing poor soil loading and requiring a much smaller compacted soil layer 567 (as compared to compacted soil layer 566 of placement 558) or no compacted soil layer at all, saving time and/or cost.

The LBCC 501 may be delivered to a work site via truck and pumped or otherwise dispensed into the excavation. In other implementations, the excavation is replaced by a containment form, which may be man-made (e.g., an assembly of wood, plastic, and/or concrete forms) or be naturally occurring (e.g., a geological formation). The excavation or containment form may also have a variety of shapes, sizes, and depths. Further, placement of the LBCC 501 may occur in stages (or lifts) to achieve a desired depth. Staged placement of the LBCC 501 keeps the weight of added wet mix from collapsing a matrix of micro-bubbles (not shown) within the LBCC 501 prior to curing.

LBCC may be made from a wide range of base mixes and with the foam comprising a wide variety of the base mix composite volume. Further, LBCC can be made in a broad range of densities to accommodate a variety of applications and circumstances. Table 3 below exemplifies the broad LBCC density range and lists nine examples at nine different densities made using one base mix comprised of Portland cement and water only. A nearly infinite number of additional solutions are possible as well. By changing the composition of the base mix (e.g., by replacing some of the Portland cement with a like percentage of a specific fly ash, slag cement, etc.), or by varying the relative quantity of foam, the number of resulting mix designs is nearly infinite. The component quantities shown in Table 3 for each cast density (made up of Portland cement, water, and foam) combine to equal one cubic yard (27 cubic feet), or one cubic meter of LBCC.

TABLE 3

| | | Average | | | | | | Average | |
|---|---|---|---|---|---|---|---|---|---|
| Cast | | Compressive | | Portland | | | | Foam | |
| Density | | Strength (28 days) | | Cement | | Water | | Volume | |
| lb/ft³ | kg/m³ | psi | MPa | lb/yd³ | kg/m³ | gal | L | ft³/yd³ | m³/m³ |
| 20 | 320 | 50 | 0.34 | 328 | 195 | 20 | 98 | 22.7 | 0.84 |
| 25 | 400 | 80 | 0.55 | 420 | 249 | 25 | 125 | 21.5 | 0.80 |
| 30 | 481 | 140 | 0.97 | 512 | 304 | 31 | 152 | 20.3 | 0.75 |
| 35 | 561 | 210 | 1.45 | 603 | 358 | 36 | 179 | 19.1 | 0.71 |
| 40 | 641 | 330 | 2.28 | 695 | 412 | 42 | 208 | 17.9 | 0.66 |
| 45 | 721 | 450 | 3.10 | 787 | 467 | 47 | 234 | 16.7 | 0.62 |
| 50 | 801 | 640 | 4.41 | 878 | 521 | 53 | 260 | 15.5 | 0.57 |
| 55 | 881 | 790 | 5.45 | 970 | 575 | 58 | 288 | 14.3 | 0.53 |
| 60 | 961 | 930 | 6.41 | 1062 | 630 | 64 | 315 | 13.1 | 0.49 |

In one example from Table 3, the LBCC material has a cast density of 30 pounds per cubic foot (lbs./ft³) and is comprised of 512 lbs. of Portland cement, 31 gallons (258.5 lbs.) of water, and 20.3 cubic feet (ft³) of foam. In this example, the foam comprises 75% of the total volume of one cubic yard of the LBCC material. Even with this high percentage of foam, which has no inherent strength of its own, a resulting cured LBCC product yields a typical average compressive strength of about 140 pounds per square inch (psi). When used as a replacement for poor soils, this material may be stronger that the soil, while being much lighter in weight, not subject to erosion, and providing a low to non-buoyant solution in the presence of water.

In another example from Table 3, the LBCC material has a cast density of 60 lbs./ft³ and is comprised of 1062 lbs. of Portland cement, 64 gallons (533.8 lbs.) of water and 13.1 ft³ of foam. In this example, the foam comprises about 22% of the volume of the mixture and a resulting cured LBCC product may yield a typical average compressive strength of about 930 psi. The dry unit weight of the cured LBCC product may be about 55 pcf, which is less than the unit weight of water. The characteristics of the LBCC material from this example, will cause it to saturate in the presence of water, to a density greater than that of water (62.4 pcf), causing it to be non-buoyant. The LBCC product from this example would be useful in an application that requires a material that is lighter than soil but has a much higher compressive strength and is non-buoyant.

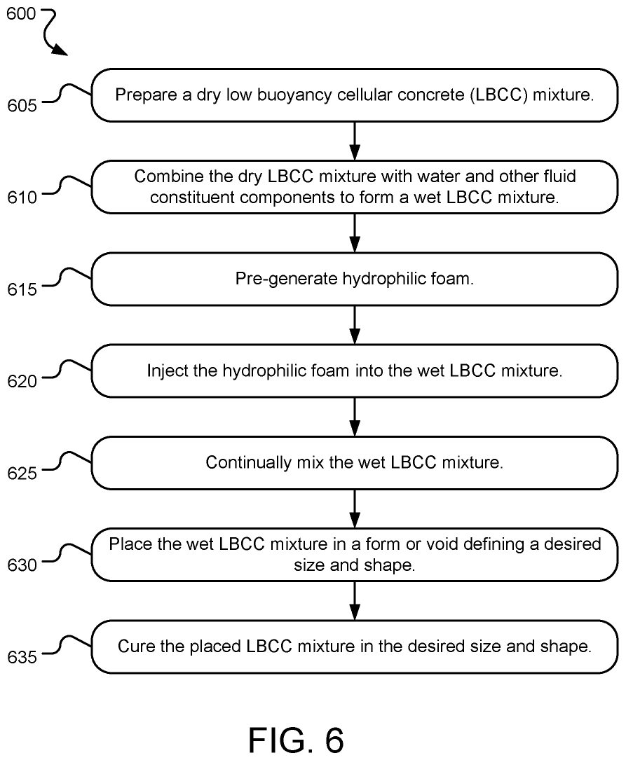

FIG. 6 illustrates example operations 600 for preparing and using a low buoyancy cellular concrete (LBCC) product. Preparing operation 605 prepares a dry LBCC mixture. The dry mixture includes one or more of cement, aggregates, powdered foaming agent(s), powdered cellulose ether(s), and other powdered chemical and/or mineral admixtures. The constituent components of the dry mixture are blended together such that the resulting dry mixture has a substantially uniform composition. In various implementations, the dry mixture may contain 2% to 98% (or 5% to 95%) fly ash, 2% to 98% (or 5% to 80%) cement, or 2% to 98% (or 5% to 95%) cement aggregates, by weight. The dry mixture may also include 0.01% to 30% by weight of cellulose ether(s) (or hydrocolloid polymer(s)).

A combining operation 610 combines the dry mixture with water and other fluid constituent components. In various implementations, the water can range from 5% to 80% (or 2% to 60%) by weight of the dry mixture. The other fluid constituent components may include fluid foaming agent(s), fluid cellulose ether(s), and other fluid chemical and/or mineral admixtures. The water and other fluid constituent components are mixed with the dry mixture together to form a wet LBCC mixture. The temperature of the water may range from 0 to 50 degrees Celsius. In some implementations, the dry LBCC mixture may reduce the coagulation caused by the addition of high-temperature water, thereby preserving eventual compressive strength of the LBCC.

In some implementations, the preparing operation 605 and the combining operation 610 are performed simultaneously. In such cases, the base mix slurry may comprise between about 2% and about 60% water and between about 5% and 80% Portland cement, by weight. Other constituents may be added to the base mix slurry, such as about 5% to about 80% sand, about 5% to about 100% pozzolan, and/or about 2% to about 95% fly ash, by weight. Pozzolans useful in LBCC may include any vitreous silicate that, when combined with calcium hydroxide, exhibits cementitious properties, such as fly ash, bottom ash, slag cement, kiln dust and other calcium silicates.

Combination (and mixing) of the water, the other fluid constituent components, and the dry mixture can be achieved in a drum mixer, a continuous mixer, or any other type of mixer that can create sufficient shear forces to thoroughly mix the constituent components to create a substantially uniform wet mixture. In implementations where powered foaming agent(s) are added in operation 605 and/or fluid foaming agent(s) are added in operation 610, the mixing is performed with sufficient shear forces to not only thoroughly mix the constituent components but generate a matrix of micro-bubbles within the wet mixture, which will ultimately yield low buoyancy cellular concrete.

A pre-generation operation 615 pre-generates hydrophilic foam. The hydrophilic foam components and additives combine to create a hydrophilic condition in the hardened LBCC product, which increases its inclination and capacity for water absorption via capillary action therein. The hydrophilic foam can include non-ionic, cationic, and anionic surfactants (or “foaming agents”), a solvent (e.g., water), and/or pressurized air, for example. The surfactant mixture may also include methylcellulose, hydroxypropyl, and/or sodium chloride, for example. The surfactant mixture can range from 0.01% to 30% by volume of diluted water. The resulting foam may include 0.2% to 20% water, 10% to 60% foaming agent, and pressurized air is delivered at about 0.5 to about 100 scfm resulting in a hydrophilic foam having a density of about 1.0 to about 5.0 pounds per cubic foot. Further, the hydrophilic foam may be enhanced using other chemical admixtures, such as mid to high range water reducers (that increase water absorption), anticoagulants, anti-washouts and/or polymers. Further, the pre-generated hydrophilic foam may comprise 10% to 95% of the base composite volume of the dry mixture.

In other implementations the hydrophilic foam is not pre-generated (that is, a foam concentrate is instead added to the base mix slurry for mixing and generation of foam). In such cases, the foam may be added to the vessel where the base mix slurry is being mixed in a continuous-type tumbling mixer or by an auger configuration, or the foam may be added into a concrete hose line through which the base mix slurry is passing in an in-line mixing configuration.

An injection operation 620 injects the hydrophilic foam prepared in operation 615 into the wet mixture created in operation 610. The hydrophilic foam may have the unique ability to promote absorption of water into a resulting cured cellular concrete product via capillary action. The injection operation 620 may be aided by adding the foam to a vessel where the wet mixture is being mixed in a continuous-type tumbling mixer, by an auger, or through a hose line through which the wet mixture slurry is passing in an in-line mixing configuration, or some other mixing apparatus.

The hydrophilic foam, whether pre-generated or not, provides millions of micro-bubbles within the wet LBCC. Upon injecting the hydrophilic foam into the base mix slurry to form the wet LBCC, a cell structure begins to develop that, upon curing, will absorb water and provide a hydraulic conductivity value (K) ranging from about 1 to about 1×10⁻⁸ cm/sec. The pre-generation operation 615 and the injection operation 620 may be omitted where powdered foaming agent(s) are added in operation 605 and/or the fluid foaming agent(s) are added in operation 610 and the foam is generated within the wet mixture in the combining (and mixing) operation 610.

A mixing operation 625 continually mixes the wet LBCC mixture to prevent the wet mixture from prematurely setting prior to placement. In various implementations, duration of the mixing operation 625 may range from 5 seconds to 90 minutes (or more precisely, 30 seconds to 15 minutes). The mixing operation 625 may be performed by a low energy drum mixer, a high shear/speed colloidal mixer, or a volumetric/continuous mobile mixer, for example. In some implementations, a high sheer speed mixing of the wet LBCC may result in a better compressive strength of the resulting cured LBCC. The mixing operation 625 creates a foamed wet LBCC mixture that retains its cellular matrix of micro-bubbles for a time period sufficient to place and cure the LBCC product (see operations 630, 635, discussed in detail below). The wet LBCC may achieve and maintain a desired consistency from about one minute to three hours after the mixing operation 625, for example.

A placing operation 630 places the wet LBCC in a form or void defining a desired size and shape for the LBCC product. The form or void may take any available size or shape and the wet LBCC is pumped or dispensed into place within the form. In various implementations, the LBCC is readily pumpable, having a slump range of about 2 to about 11.5 inches.

A curing operation 635 cures the LBCC in the desired size and shape. Since the matrix of micro-bubbles does not significantly dissipate prior to curing, the cured LBCC product includes the matrix of micro-bubbles as an integrated and permanent feature of the LBCC product. Further, the cured LBCC product exhibits a cell structure created from the micro-bubbles allowing for saturation through water absorption via capillary action, a hydraulic conductivity value (K) of about 1 to about 1×10⁻⁸ cm/sec, a density range of between about 10 and 58 pounds per cubic foot, with a compressive strength between about 10 and about 1200 pounds per square inch (psi).

The logical operations making up the embodiments of the invention described herein are referred to variously as operations, steps, objects, or modules. Furthermore, the logical operations may be performed in any order, adding or omitting operations as desired, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A cured low buoyancy cellular concrete comprising:
cement distributed throughout the low buoyancy cellular concrete;
aggregate distributed throughout the low buoyancy cellular concrete; and
a foaming agent residue that defines a distributed array of micro-bubbles within the low buoyancy cellular concrete, wherein a density of the low buoyancy cellular concrete is greater than 930 kg/m³ when water is allowed to absorb into the low buoyancy cellular concrete and less than 930 kg/m³ when water is allowed to exude from the low buoyancy cellular concrete.

2. The cured low buoyancy cellular concrete of claim 1, wherein the water displaces air within the micro-bubbles when water is allowed to absorb into the low buoyancy cellular concrete and air displaces water within the micro-bubbles when the water is allowed to exude from the low buoyancy cellular concrete.

3. The cured low buoyancy cellular concrete of claim 1, wherein water is drawn into the cured low buoyancy cellular concrete between the micro-bubbles via capillary action when water is allowed to absorb into the low buoyancy cellular concrete and water is drawn out of the cured low buoyancy cellular concrete between the micro-bubbles via capillary action when water is allowed to exude from the low buoyancy cellular concrete.

4. The cured low buoyancy cellular concrete of claim 3, wherein water is absorbed through a cementious matrix into the cured low buoyancy cellular concrete and exuded through the cementious matrix out of the cured low buoyancy cellular concrete.

5. The cured low buoyancy cellular concrete of claim 1, wherein the foaming agent residue includes a hydrophilic additive.

6. The cured low buoyancy cellular concrete of claim 1, having a hydraulic conductivity (K) value of 1 to 1×10⁻⁸ cm/sec, a cast density range of 10 to 58 pounds per cubic foot (pcf), a saturated density of 40 to 80 pcf, with a compressive strength of 10 to 1200 psi, and absorption into the cured low buoyancy cellular concrete of 10 to 90 percent of a mass of the cured low buoyancy cellular concrete.

7. The cured low buoyancy cellular concrete of claim 1, wherein the distributed array of micro-bubbles are configured in a manner than renders the cured low buoyancy cellular concrete pervious to water.

8. The cured low buoyancy cellular concrete of claim 1, wherein the distributed array of micro-bubbles are configured in a manner than renders the cured low buoyancy cellular concrete impervious to water.

9. The cured low buoyancy cellular concrete of claim 1, having a density of greater than 58 lb/ft³ at greater than 92% water saturation.

10. The cured low buoyancy cellular concrete of claim 1, having a density of less than 55 lb/ft³ at less than 8% water saturation.

11. A wet low buoyancy cellular concrete comprising:
water distributed throughout the wet low buoyancy cellular concrete;
cement distributed throughout the wet low buoyancy cellular concrete;
aggregate distributed throughout the wet low buoyancy cellular concrete; and
a foaming agent distributed throughout the wet low buoyancy cellular concrete, wherein the wet low buoyancy cellular concrete contains a distributed array of micro-bubbles that substantially maintain their presence in the wet low buoyancy cellular concrete as it cures, and wherein the foaming agent includes a hydrophilic additive.

12. A method of manufacturing a low buoyancy cellular concrete product comprising:
combining water, a foaming agent including a hydrophilic additive, cement, and aggregate to create a wet low buoyancy cellular concrete that contains a distributed array of micro-bubbles that substantially maintain their presence in a wet low buoyancy cellular concrete as it cures; and
curing the wet low buoyancy cellular concrete to create the low buoyancy cellular concrete product, wherein a density of the low buoyancy cellular concrete product is greater than 930 kg/m³ when water is allowed to absorb into the low buoyancy cellular concrete product and less than 930 kg/m³ when water is allowed to exude from the low buoyancy cellular concrete product.

13. The method of claim 12, further comprising:
placing the wet low buoyancy cellular concrete within a form or a void prior to curing the wet low buoyancy cellular concrete to create the low buoyancy cellular concrete product.

14. The method of claim 12, wherein the combining operation further includes adding one or more of cement, aggregates, chemical admixtures, and mineral admixtures to create the wet low buoyancy cellular concrete.

15. The method of claim 12, wherein water displaces air within the micro-bubbles when water is allowed to absorb into the low buoyancy cellular concrete product and air displaces water within the micro-bubbles when the water is allowed to exude from the low buoyancy cellular concrete product.

16. The method of claim 12, wherein water is drawn into the low buoyancy cellular concrete product between the micro-bubbles via capillary action when water is allowed to absorb into the low buoyancy cellular concrete product and water is drawn out of the low buoyancy cellular concrete product between the micro-bubbles via capillary action when water is allowed to exude from the low buoyancy cellular concrete product.

17. The method of claim 12, wherein water is absorbed through a cementious matrix into the low buoyancy cellular concrete product and exuded through the cementious matrix out of the low buoyancy cellular concrete product.

18. The method of claim 12, wherein the low buoyancy cellular concrete product has a density of greater than 58 lb/ft³ at greater than 92% water saturation.

19. The method of claim 12, wherein the low buoyancy cellular concrete product has a density of less than 55 lb/ft³ at less than 8% water saturation.

20. The method of claim 12, wherein the distributed array of micro-bubbles are configured in a manner than renders the low buoyancy cellular concrete product pervious to water.
